(19) United States
(12) Patent Application Publication
(10) Pub. No.: US 2019/0019500 A1
(43) Pub. Date: Jan. 17, 2019

(54) APPARATUS FOR DEEP LEARNING BASED TEXT-TO-SPEECH SYNTHESIZING BY USING MULTI-SPEAKER DATA AND METHOD FOR THE SAME

(71) Applicants: Electronics and Telecommunications Research Institute, Daejeon (KR); YONSEI UNIVERSITY INDUSTRY FOUNDATION (YONSEI UIF), Seoul (KR)

(72) Inventors: In Seon JANG, Daejeon (KR); Hong Goo KANG, Seoul (KR); Hyeon Joo KANG, Seoul (KR); Young Sun Joo, Seoul (KR); Chung Hyun AHN, Daejeon (KR); Jeong Il SEO, Daejeon (KR); Seung Jun YANG, Daejeon (KR); Ji Hoon CHOI, Daejeon (KR)

(73) Assignees: Electronics and Telecommunications Research Institute, Daejeon (KR); YONSEI UNIVERSITY INDUSTRY FOUNDATION (YONSEI UIF), Seoul (KR)

(21) Appl. No.: 16/035,261

(22) Filed: Jul. 13, 2018

(30) Foreign Application Priority Data
Jul. 13, 2017 (KR) 10-2017-0088994
Nov. 7, 2017 (KR) 10-2017-0147101
Jul. 13, 2018 (KR) 10-2018-0081395

(51) Int. Cl. G10L 13/04; G10L 15/02; G10L 15/32; G10L 15/06

(52) U.S. Cl. CPC G10L 13/04; G10L 15/063; G10L 15/32; G10L 15/02

(57) ABSTRACT

Disclosed is a method and apparatus for training a speech signal. A speech signal training apparatus of the present disclosure may include a target speaker speech database storing a target speaker speech signal; a multi-speaker speech database storing a multi-speaker speech signal; a target speaker acoustic parameter extracting unit extracting an acoustic parameter of a training subject speech signal from the target speaker speech signal; a similar speaker acoustic parameter determining unit extracting at least one similar speaker speech signal from the multi-speaker speech signals, and determining an auxiliary speech feature of the similar speaker speech signal; and an acoustic parameter model training unit determining an acoustic parameter model by performing model training for a relation between the acoustic parameter and text by using the acoustic parameter and the auxiliary speech feature, and setting mapping information of the relation between the acoustic parameter model and the text.

### CROSS REFERENCE TO RELATED APPLICATION

The present application claims priority to Korean Patent Application Nos. 10-2017-0088994, 10-2017-0147101, and 10-2018-0081395 filed Jul. 13, 2017, Nov. 7, 2017, and Jul. 13, 2018 the entire contents of which is incorporated herein for all purposes by this reference.

### BACKGROUND OF THE INVENTION

### Field of the Invention

The present disclosure relates generally to a method of generating a synthesized speech. More particularly, the present disclosure relates to a method and apparatus for generating an acoustic parameter that becomes a basis of generating a synthesized speech.

### Description of the Related Art

A text-to-speech (TTS) system outputs input text to a speech and is used for synthesizing a speech with natural and high sound quality. A text-to-speech synthesis method may be classified into a concatenative synthesis method and a synthesis method based on a statistical parametric model.

In the concatenative synthesis method, a speech is synthesized by using a method of combining a speech in a division unit such as phoneme, word, sentence, etc. The above method provides a high synthesis sound quality, but it has a limitation that the method requires a large-capacity database to be built in a system since the method is performed on the assumption of the same. In addition, since only recorded signals are used, expanding the method by transforming a tome or rhythm of a synthesis sound is difficult.

In a speech synthesis method based on a statistical parametric model, an acoustic parameter extracted from a speech signal is trained in a statistical model, and then a speech is synthesized by generating a parameter corresponding to text from the statistical model. Although the sound quality of the above method is lower than that of the concatenative synthesis method, since the method uses only a representative value extracted from a speech signal, less memory is required, thus being suitable for the mobile system. In addition, transforming a model by changing a parameter value is easy to perform. As statistical mode types, hidden Markov model (HMM) and deep learning based model are used. Among them, modeling a non-linear relation between data (feature) is available by using deep learning based model so that the deep learning based model is widely used recently.

The foregoing is intended merely to aid in the understanding of the background of the present invention, and is not intended to mean that the present invention falls within the purview of the related art that is already known to those skilled in the art.

### SUMMARY OF THE INVENTION

An acoustic parameter is configured with an excitation parameter and a spectral parameter. When speech synthesis is performed by using a deep learning based model, a spectral parameter is well trained, but relatively, an excitation parameter is hard to configure a model by performing training.

Particularly, even though a person pronounces the same phoneme, the form of speech changes due to an influence of surrounding phonemes, syllables, and words, and a pattern of a speech signal may vary according to the speaker's own personality and emotional situation. However, when a speech signal is trained by applying a deep learning based model, training is performed to converge to a specific value so that there is limit of effectively modeling an excitation parameter having a large deviation of data. Accordingly, a trajectory of an excitation parameter estimated as above may become over-smoothing.

Further, when a speech signal is synthesized by using a model where an excitation parameter is modeled in a manner of over-smoothing, a feature of various patterns of a target speaker may not be properly represented, and furthermore, the quality of the synthesized tone may be lowered. When a speech signal of a target speaker is sufficiently trained for various patterns, the above problem may be solved. However, there is limit in terms of time and cost to construct a target speaker speech signal as a large-capacity database.

Accordingly, the present invention has been made keeping in mind the above problems occurring in the related art, and the present invention is intended to provide a method and apparatus for training a speech signal, the method and apparatus being capable of implementing an acoustic parameter model in which features of various patterns of a target speaker is reflected by using a multi-speaker speech signal.

Another object of the present disclosure is to provide a method and apparatus for training a speech signal, the method and apparatus being capable of implementing an acoustic parameter model by selecting one of multiple speakers through which a feature of a target speaker speech signal is accurately reflected while using a multi-speaker speech signal.

Still another object of the present disclosure is to provide a method and apparatus for training a speech signal, the method and apparatus being optimized for a target speaker speech feature by considering interaction between speech features and interaction of a sound feature between other speakers.

Still another object of the present disclosure is to provide a method and apparatus for implementing an acoustic parameter model in which various patterns of a target speaker are reflected by using a multi-speaker speech signal, and generating a synthesized speech in association with input text by using the implemented acoustic parameter model

It will be appreciated by persons skilled in the art that the objects that could be achieved with the present disclosure are not limited to what has been described hereinabove and the above and other objects that the present disclosure could achieve will be more clearly understood from the following detailed description.

According to one aspect of the present disclosure, there is provided an apparatus for training a speech signal. The apparatus may include: a target speaker speech database storing a target speaker speech signal; a multi-speaker speech database storing a multi-speaker speech signal; a target speaker acoustic parameter extracting unit extracting an acoustic parameter of a training subject speech signal from the target speaker speech signal; a similar speaker acoustic parameter determining unit extracting at least one similar speaker speech signal from the multi-speaker speech signals, and determining an auxiliary speech feature of the similar speaker speech signal; and an acoustic parameter model training unit determining an acoustic parameter model by performing model training for a relation between the acoustic parameter and text by using the acoustic parameter and the auxiliary speech feature, and setting mapping information of the relation between the acoustic parameter model and the text;

According to another aspect of the present disclosure, there is provided a method of training a speech signal. The method may include: extracting an acoustic parameter of a training subject speech signal from a target speaker speech database storing a target speaker speech signal; extracting at least one similar speaker speech signal from a multi-speaker speech database storing a multi-speaker speech signal; determining an auxiliary speech feature of the similar speaker speech signal; and determining an acoustic parameter model by performing model training of a relation between the acoustic parameter and text by using the acoustic parameter and the auxiliary speech feature, and setting mapping information of the relation between the acoustic parameter model and the text.

According to another aspect of the present disclosure, there is provided an apparatus for speech synthesis. The apparatus may include: a target speaker speech database storing a target speaker speech signal; a multi-speaker speech database storing a multi-speaker speech signal; a target speaker acoustic parameter extracting unit extracting an acoustic parameter of a training subject speech signal from the target speaker speech signal; a similar speaker acoustic parameter determining unit extracting at least one similar speaker speech signal from the multi-speaker speech signals, and determining an auxiliary speech feature of the similar speaker speech signal; an acoustic parameter model training unit determining an acoustic parameter model by performing model training for a relation between the acoustic parameter and text by using the acoustic parameter and the auxiliary speech feature, and setting mapping information of the relation between the acoustic parameter model and the text; and a speech signal synthesizing unit generating the acoustic parameter in association with input text based on the mapping information of the relation between the acoustic parameter and the text, and generating a synthesized speech signal in association with the input text.

According to another aspect of the present disclosure, there is provided a method of speech synthesis. The method may include: extracting an acoustic parameter of a training subject speech signal from a target speaker speech database storing a target speaker speech signal; extracting at least one similar speaker speech signal from a multi-speaker speech database storing a multi-speaker speech signal; determining an auxiliary speech feature of the similar speaker speech signal; determining an acoustic parameter model by performing model training of a relation between the acoustic parameter and text by using the acoustic parameter and the auxiliary speech feature, and setting mapping information of the relation between the acoustic parameter model and the text; generating the acoustic parameter in association with input text based on the mapping information of the relation between the acoustic parameter and the text, and generating a synthesized speech signal in association with the input text by reflecting the generated acoustic parameter.

According to another aspect of the present disclosure, there is provided an apparatus for training a speech signal. The apparatus may include: a target speaker speech database storing a target speaker speech signal; a multi-speaker speech database storing a multi-speaker speech signal; a target speaker acoustic parameter extracting unit extracting first and second target speaker speech features from the target speaker speech signal; a similar speaker data selecting unit extracting first and second multi-speaker speech features from the multi-speaker speech signal, and selecting at least one similar speaker speech signal based on the extracted first and second multi-speaker speech features and the extracted first and second target speaker speech features; a similar speaker speech feature determining unit determining first and second speech features of the similar speaker speech signal; and a speech feature model training unit performing model training for a relation between the first and second speech features and text based on the first and seconds target speaker speech features of the target speaker and the similar speaker, and setting mapping information of the relation between the first and second speech features and the text.

According to another aspect of the present disclosure, there is provided a method of training a speech signal. The method may include: extracting first and second target speaker speech features from a target speaker speech signal; extracting first and second multi-speaker speech features from a multi-speaker speech signal, and selecting at least one similar speaker speech signal based on the extracted first and second target speaker speech features and the first and second multi-speaker speech features; and determining first and second similar speaker speech signals of the similar speaker speech signal, and performing model training for a relation between the first and second speech features and text based on the first and second speech features of the target speaker and the similar speaker and setting mapping information of the relation between the first and second speech features and the text.

According to another aspect of the present disclosure, there is provided an apparatus for speech synthesis. The apparatus may include: a target speaker speech database storing a target speaker speech signal; a multi-speaker speech database storing a multi-speaker speech signal; a target speaker acoustic parameter extracting unit extracting first and second target speaker speech features from the target speaker speech signal; a similar speaker data selecting unit extracting first and second multi-speaker speech features from the multi-speaker speech signal, and selecting at least one similar speaker speech signal based on the extracted first and second multi-speaker speech features and the extracted first and second target speaker speech features; a similar speaker speech feature determining unit determining first and second speech features of the similar speaker speech signal; a speech feature model training unit performing model training for a relation between the first and second speech features and text based on the first and seconds target speaker speech features of the target speaker and the similar speaker, and setting mapping information of the relation between the first and second speech features and the text; and a speech signal synthesizing unit generating a speech feature in association with input text based on mapping information of the relation between the first and second features and the text, and generating a synthesized speech signal in association with the input text by reflecting the generated speech feature.

According to another aspect of the present disclosure, there is provided a method of speech synthesis. The method may include: extracting first and second target speaker speech features from a target speaker speech signal; extracting first and second multi-speaker speech features from a multi-speaker speech signal, and selecting at least one similar speaker speech signal based on the extracted first and second target speaker speech features and the first and second multi-speaker speech features; and determining first and second similar speaker speech signals of the similar speaker speech signal, and performing model training for a relation between the first and second speech features and text based on the first and second speech features of the target speaker and the similar speaker and setting mapping information of the relation between the first and second speech features and the text;

determining a speech feature in association with input text based on mapping information of the relation between the first and second speech features and the text, and generating a synthesized speech signal in association with the input text by reflecting the determined speech feature.

It is to be understood that the foregoing summarized features are exemplary aspects of the following detailed description of the present disclosure without limiting the scope of the present disclosure.

According to the present disclosure, there is provided a method and apparatus for training a speech signal, whereby the method and apparatus can implement an acoustic parameter model in which features of various patterns of a target speaker are reflected by using a multi-speaker speech signal.

In addition, according to the present disclosure, there is provided a method and apparatus for implementing an acoustic parameter model in which feature of various patterns of a target speaker is reflected by using a multi-speaker speech signal, and generating a synthesized speech in association with input text by using the implemented acoustic parameter model.

It will be appreciated by persons skilled in the art that the effects that can be achieved with the present disclosure are not limited to what has been particularly described hereinabove and other advantages of the present disclosure will be more clearly understood from the following detailed description taken in conjunction with the accompanying drawings.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a view of a block diagram showing a configuration of a speech signal training apparatus according to an embodiment of the present disclosure;

FIG. 2 is a view of a block diagram showing a detailed configuration of a similar speaker speech signal determining unit included in the speech signal training apparatus according to the present disclosure;

FIG. 3 is a view showing where a feature parameter section dividing unit of FIG. 2 performs temporal alignment for a speech signal;

FIG. 4 is a view of a block diagram showing a configuration of a speech signal synthesis apparatus that includes the speech signal training apparatus according to an embodiment of the present disclosure;

FIG. 5 is a view of a block diagram showing a configuration of a speech signal training apparatus according to another embodiment of the present disclosure;

FIG. 6 is a view of a block diagram showing a detailed configuration of a similar speaker data selecting unit included in the speech signal training apparatus according to another embodiment of the present disclosure;

FIG. 7 is a view of an example showing where a second speech feature section dividing unit of FIG. 6 performs temporal alignment for a speech signal;

FIG. 8 is a view of an example of a neural network model through which an acoustic parameter model training unit of FIG. 5 uses a target speaker speech feature and a multi-speaker speech feature;

FIGS. 9A and 9B are views of an example showing a configuration of a neural network adapting unit included in the speech signal training apparatus according to another embodiment of the present disclosure;

FIG. 10 is a view of a block diagram showing a configuration of a speech signal synthesis apparatus according to another embodiment of the present disclosure;

FIG. 11 is a view of a flowchart showing steps of a speech signal training method according to an embodiment of the present disclosure;

FIG. 12 is a view of a flowchart showing a speech signal training method according to an embodiment of the present disclosure;

FIG. 13 is a view of a flowchart showing of a speech signal training method according to another embodiment of the present disclosure;

FIG. 14 is a view of a flowchart showing of a speech signal synthesis method according to another embodiment of the present disclosure; and

FIG. 15 is a view of a block diagram showing an example of a computing system that executes a speech signal training method/apparatus, a speech signal training method/apparatus, and a speech signal synthesis method/apparatus according to various embodiments of the present disclosure.

### DETAILED DESCRIPTION OF THE INVENTION

Hereinbelow, exemplary embodiments of the present disclosure will be described in detail with reference to the accompanying drawings such that the present disclosure can be easily embodied by one of ordinary skill in the art to which this invention belongs. However, the present disclosure may be variously embodied, without being limited to the exemplary embodiments.

In the description of the present disclosure, the detailed descriptions of known constitutions or functions thereof may be omitted if they make the gist of the present disclosure unclear. Also, portions that are not related to the present disclosure are omitted in the drawings, and like reference numerals designate like elements.

In the present disclosure, when an element is referred to as being “coupled to”, “combined with”, or “connected to” another element, it may be connected directly to, combined directly with, or coupled directly to another element or be connected to, combined directly with, or coupled to another element, having the other element intervening therebetween. Also, it should be understood that when a component “includes” or “has” an element, unless there is another opposite description thereto, the component does not exclude another element but may further include the other element.

In the present disclosure, the terms “first”, “second”, etc. are only used to distinguish one element, from another element. Unless specifically stated otherwise, the terms “first”, “second”, etc. do not denote an order or importance. Therefore, a first element of an embodiment could be termed a second element of another embodiment without departing from the scope of the present disclosure. Similarly, a second element of an embodiment could also be termed a first element of another embodiment.

In the present disclosure, components that are distinguished from each other to clearly describe each feature do not necessarily denote that the components are separated. That is, a plurality of components may be integrated into one hardware or software unit, or one component may be distributed into a plurality of hardware or software units. Accordingly, even if not mentioned, the integrated or distributed embodiments are included in the scope of the present disclosure.

In the present disclosure, components described in various embodiments do not denote essential components, and some of the components may be optional. Accordingly, an embodiment that includes a subset of components described in another embodiment is included in the scope of the present disclosure. Also, an embodiment that includes the components described in the various embodiments and additional other components are included in the scope of the present disclosure.

In the present disclosure, terms such as acoustic parameter, second are used only for the purpose of distinguishing one element from another, and do not limit the order or importance of elements, etc. unless specifically mentioned. Accordingly, a configuration element of an acoustic parameter of an embodiment within the range of the present disclosure may be referred as a second configuration element in another embodiment. Similarly, a second configuration element in another embodiment may be referred as a configuration element of an acoustic parameter in another embodiment.

Hereinafter, an embodiment of the present disclosure will be described with reference to the accompanied drawings.

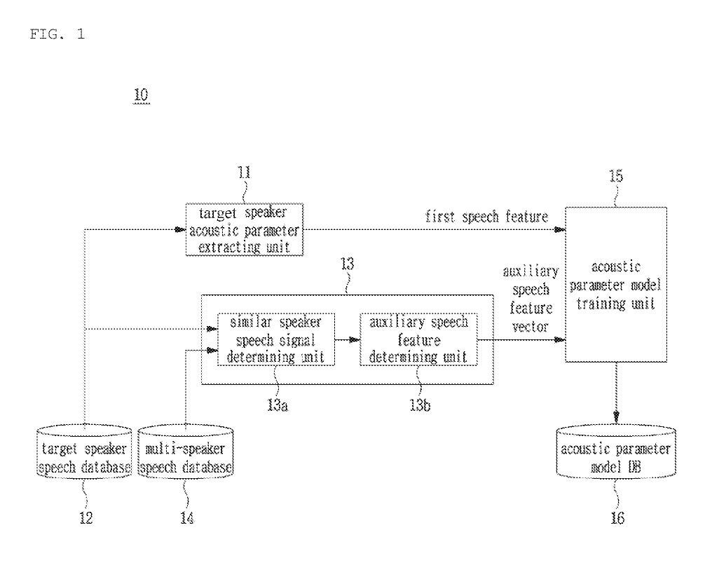

FIG. 1 is a view showing a block diagram of a configuration of a speech signal training apparatus according to an embodiment of the present disclosure.

The speech signal training apparatus according to an embodiment of the present disclosure may include a target speaker acoustic parameter extracting unit 11, a target speaker speech database 12, a similar speaker acoustic parameter determining unit 13, a multi-speaker speech database 14, and an acoustic parameter model training unit 15.

A target speaker speech signal may be divided by a phoneme unit that is a minimum unit for distinguishing a meaning of a word in a phonetic system of language. The speech signal shows various patterns according to a conversation method, an emotional state, a composition of sentence so that various patterns may be represented in a speech signal in response to a conversation method, an emotional state, a composition of sentence even though a speech signal of the same phoneme unit is provided. For a target speaker speech signal, in order to perform training for respective various patterns, a large amount of data for the target speaker speech signal is required. However, data of the target speaker speech signal is hard to obtain, a training method capable of reflecting various patterns in a multi-speaker speech signal by using data is implemented.

In addition, when training is performed by using data of a multi-speaker speech signal, a feature of various patterns of a target speaker has to be represented. However, due to a feature of a training or learning algorithm, the trained speech signal becomes over-smoothing so that features of various patterns of a target speaker are not properly represented and the liveness may be degraded.

In order to solve the above problem, the speech signal training apparatus according to an embodiment of the present disclosure selects a speech signal including a feature similar to a target speaker speech signal to which training is performed, that is, a training subject speech signal, among multi-speaker speech signals stored in the multi-speaker speech database 14, and performs training for the selected speech signal.

For this, the target speaker acoustic parameter extracting unit 11 extracts an acoustic parameter of a training subject speech signal from the target speaker speech database 12.

The similar speaker acoustic parameter determining unit 13 detects at least one similar speaker speech signal in association with the training subject speech signal from the multi-speaker speech database 14, and determines an auxiliary speech feature of the at least one detected similar speaker speech signal. Herein, the auxiliary speech feature may include an excitation parameter or a feature vector detected from the excitation parameter.

The similar speaker acoustic parameter determining unit 13 may include a similar speaker speech signal determining unit 13a and an auxiliary speech feature determining unit 13b. The similar speaker speech signal determining unit 13a may divide at least one speech signal included in the multi-speaker speech database 14 by a partial unit of a sentence such as phoneme, syllable, word, etc., measure a similarity with a training subject speech signal based on the division unit, and select a speech signal with high similarity as a similar speaker speech signal. In addition, the auxiliary speech feature determining unit 13b may determine an auxiliary speech feature of the similar speaker speech signal based on an acoustic parameter (for example, excitation). For example, the auxiliary speech feature determining unit 13b may generate an auxiliary speech feature by reflecting a weight according to the similarity between the acoustic parameters (for example, excitation parameter) of the similar speaker speech signal and the target speaker speech signal in the similar speaker acoustic parameter.

The acoustic parameter model training unit 15 may perform model training for a relation between the acoustic parameter and text by using the acoustic parameter and the auxiliary speech feature vector, store and manage mapping information of the relation between the acoustic parameter and the text in the acoustic parameter model DB 16.

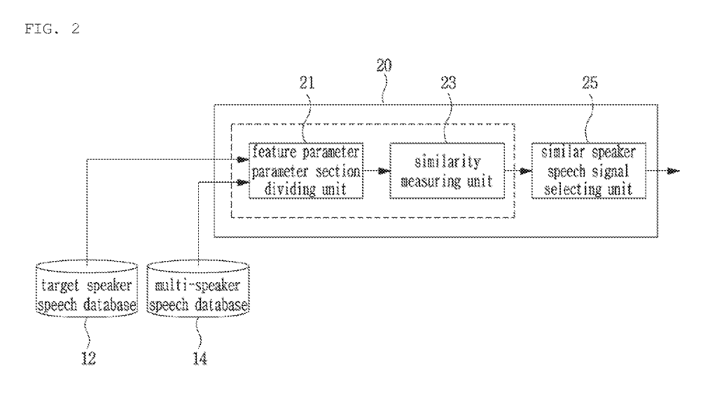

FIG. 2 is a view of a block diagram showing a detailed configuration of the similar speaker speech signal determining unit included in the speech signal training apparatus according to an embodiment of the present disclosure.

Referring to FIG. 2, the similar speaker speech signal determining unit 20 may include a feature parameter section dividing unit 21, a similarity measuring unit 23, and a similar speaker speech signal selecting unit 25.

The feature parameter section dividing unit 21 may determine an acoustic parameter (for example, excitation parameter) of a target speaker speech signal and an acoustic parameter (for example, excitation parameter) of a multi-speaker speech signal, and determine a feature vector of each acoustic parameter.

The similarity measuring unit 23 determines a similarity between a feature vector of a target speaker speech signal and a feature vector of a multi-speaker speech signal. For example, the similarity measuring unit 23 may calculate a similarity between the feature vector of the target speaker speech signal and the feature vector of the multi-speaker speech signal by using a K-means clustering method, a method of a Euclidean distance of a Wavelet coefficient extracted from a basis frequency, a Kullback-Leibler divergence method, etc.

The similar speaker speech signal selecting unit 25 may select a multi-speaker speech signal similar to a target speaker speech signal based on the similarity between the feature vector of the target speaker speech signal and the feature vector of the multi-speaker speech signal. In an embodiment of the present disclosure, a multi-speaker speech signal selected as above may be defined as a similar speaker speech signal.

Even though sentences are the same, a speech speed differs for each speaker, and thus a length of a speech signal may vary. Accordingly, in order to determine a similarity between a feature vector of a target speaker speech signal and a feature vector of a multi-speaker speech signal, setting using a temporal alignment method is required such that the lengths of the entire sentences become the same. For this, before calculating a similarity between a feature vector of a target speaker speech signal and a feature vector of a multi-speaker speech signal, the feature parameter section dividing unit 21 may perform temporal alignment for a speech signal that becomes a subject of calculating a similarity.

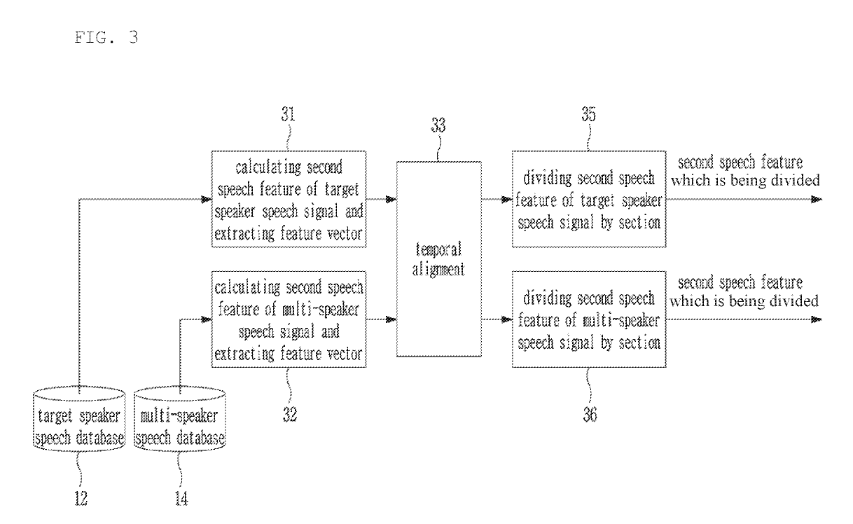

FIG. 3 is a view showing an example where the feature parameter section dividing unit 21 of FIG. 2 performs temporal alignment for a speech signal.

In 31, the feature parameter section dividing unit 21 extracts an acoustic parameter (for example, excitation parameter) from a target speaker speech signal, and a feature vector from the calculation result. Then, in 32, the feature parameter section dividing unit 21 determines an acoustic parameter (for example, excitation parameter) from a multi-speaker speech signal and a feature vector in association with the same.

In 33, the feature parameter section dividing unit 21 determines a feature vector from the target speaker speech signal and from the multi-speaker speech signal, and performs temporal alignment for acoustic parameters (for example, excitation parameter) based on the determined feature vector.

In one embodiment, the feature parameter section dividing unit 21 may determine a speech feature (for example, excitation parameter) determined from the target speaker speech signal and the multi-speaker speech signal, and a feature vector in association with the same such as mel-frequency cepstral coefficient (MFCC), first to fourth formants (F1˜F4), line spectral frequency (LSF), etc.

Then, the feature parameter section dividing unit 21 performs temporal alignment for the acoustic parameter (for example, excitation parameter) in association with the target speaker speech signal and the multi-speaker speech signal by applying a dynamic time warping (DTW) algorithm by using the above feature vector.

Then, in 35 and 36, the feature parameter section dividing unit 21 may divide the acoustic parameter (for example, excitation parameter) in association with the target speaker speech signal and the multi-speaker speech signal by a unit of language information constituting a lower level of a sentence such as phoneme, word, etc.

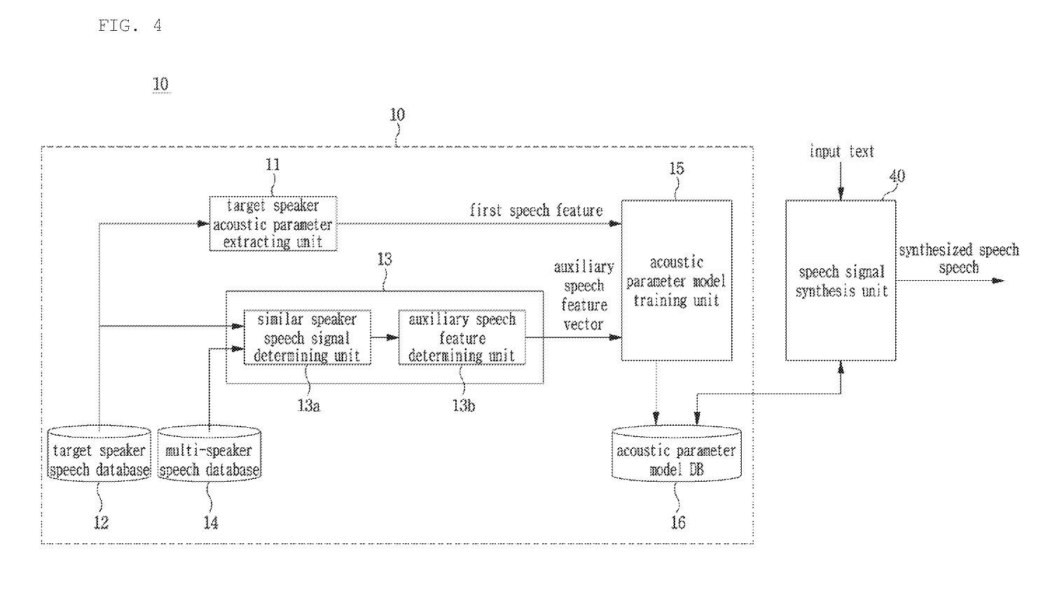

FIG. 4 is a view of a block diagram showing a configuration of a speech signal synthesis apparatus including the speech signal training apparatus according to an embodiment of the present disclosure.

The speech signal synthesis apparatus according to an embodiment of the present disclosure includes the above described speech signal training apparatus 10 according to an embodiment of the present disclosure. In FIG. 4, for configurations identical to the above described speech signal training apparatus 10 of FIG. 1, the same drawing reference numbers are given, and for detailed description related thereto, refer to FIG. 1 and the description thereof.

The speech signal training apparatus 10 performs model training for a relation between an acoustic parameter and text by using an auxiliary feature vector calculated based on an acoustic parameter detected from a target speaker speech signal and a similar speaker speech signal selected from multi-speaker speech signals. Data obtained by performing the above training, that is, mapping information of the relation between the acoustic parameter and the text may be stored and managed in the acoustic parameter model DB 16.

The speech signal synthesis apparatus includes a speech signal synthesis unit 40. The speech signal synthesis unit 40 generates an acoustic parameter in association with input text based on data stored in the acoustic parameter model DB 16, that is, mapping information of the relation between the acoustic parameter and the text, and generates a synthesized speech signal in association with the input text by reflecting the generated acoustic parameter.

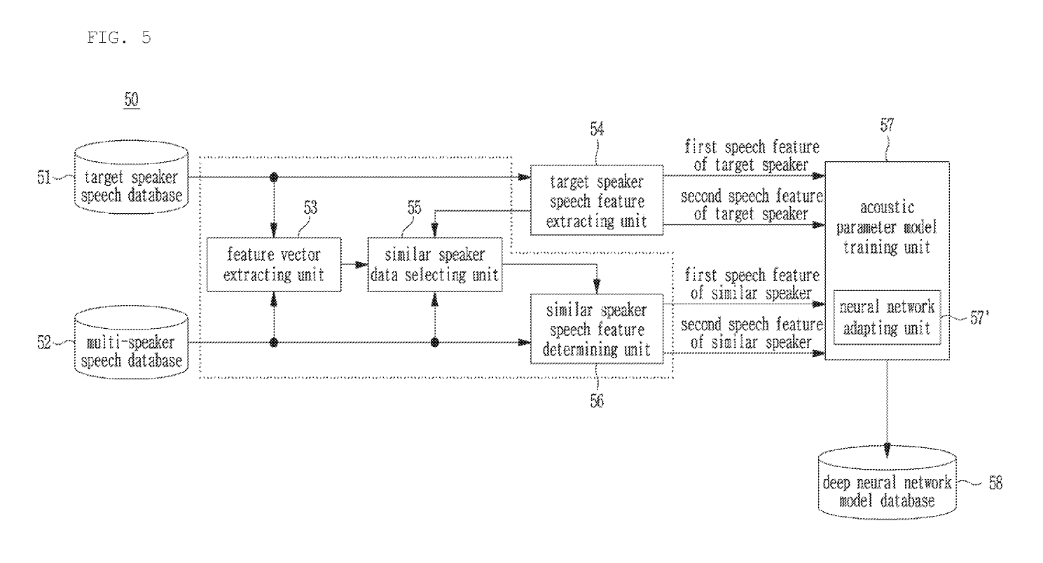

FIG. 5 is a view of a block diagram showing a configuration of a speech signal training apparatus according to another embodiment of the present disclosure.

The speech signal training apparatus according to another embodiment of the present disclosure may include a target speaker (TS) speech database 51, a multi-speaker speech database 52, a feature vector extracting unit 53, a target speaker speech feature extracting unit 54, a similar speaker (SS) data selecting unit 55, a similar speaker speech feature determining unit 56, an acoustic parameter model training unit 57, and a deep neural network model database 58.

A target speaker speech signal may be divided by a phoneme unit that is a minimum sound unit for distinguishing meaning of a word in a phonetic system of language. The speech signal shows various patterns according to a conversation method, an emotional state, a composition of sentence so that various patterns may be represented in a speech signal in response to a conversation method, an emotional state, a composition of sentence even though a speech of the same phoneme unit is provided. For a target speaker speech signal, in order to perform training for respective various patterns, a large amount of data for the speech signal of the target speaker is required. However, data of the speech signal of the target speaker is hard to obtain, a training method capable of reflecting various patterns in a multi-speaker speech signal by using data is implemented.

In addition, when training is performed for a multi-speaker speech by using data of a multi-speaker speech signal, a feature of various patterns of a target speaker has to be represented. However, due to a feature of a training algorithm, the trained speech signal becomes over-smoothing so that features of various patterns of a target speaker are not properly represented and the liveness may be degraded.

In order to solve the above problem, the speech signal training apparatus according to another embodiment of the present disclosure, among multi-speaker speech signals stored in the multi-speaker speech database 52, a target speaker speech signal for which training is performed, that is, a speech signal including a feature similar to a training subject speech signal (in other words, a similar speaker (SS) speech signal) is selected and training is performed for the same.

Based on this, the target speaker speech database 51 may store target speaker speech signals by dividing the same by a unit of phoneme, syllable, word, etc., and may store by reflecting context information in association with a target speaker speech signal, for example, a conversation method, an emotional state, sentence composition, etc. Similarly, the multi-speaker speech database 52 may store multi-speaker speech signals by dividing the same by a unit of phoneme, syllable, word, etc., and store by reflecting context information.

The feature vector extracting unit 53 may extract a feature vector of a target speaker speech signal and a multi-speaker speech signal.

In detail, the similar speaker data selecting unit 55 may divide at least one speech signal included in the multi-speaker speech database 52 by a partial unit of a sentence such as phoneme, syllable, word, etc., and determine a similarity with a target speaker speech signal based on the division unit. Herein, the similar speaker data selecting unit 55 may determine a similarity between a target speaker speech signal and a multi-speaker speech signal by using a parameter (for example, spectral parameter) representing a spectral feature and a parameter representing a basis frequency (for example, F0 parameter). Particularly, in order to accurately determine a similarity between a target speaker speech signal and a multi-speaker speech signal by using a parameter representing a basis frequency (for example, F0 parameter), performing temporal alignment for a parameter representing a basis frequency (for example, F0 parameter) of a target speaker speech signal and a multi-speaker speech signal is required.

Based on the above, the feature vector extracting unit 53 may extract a feature vector required for performing temporal alignment of a parameter representing a basis frequency. For example, the feature vector extracting unit 53 may calculate a feature vector required for performing temporal alignment by detecting a mel-frequency cepstral coefficient (MFCC), first to fourth formants (F1˜F4), a line spectral frequency (LSF), etc. of a TS speech signal and a multi-speaker speech signal.

The target speaker speech feature extracting unit 54 extracts an acoustic parameter of a training subject speech signal from the target speaker speech database 51. Various acoustic parameters may be included in a speech signal of a speaker, and various acoustic parameters required for performing training a speech signal of a speaker may be extracted based on the same. For example, the target speaker speech feature extracting unit 54 may extract a parameter representing a spectral feature of a target speaker speech signal (for example, spectral parameter), and a parameter representing a basis frequency feature of the target speaker speech signal (for example, F0 parameter).

In addition, the target speaker speech feature extracting unit 54 may determine a spectral parameter of a target speaker speech signal, output the spectral parameter as a first target speaker speech feature, and output a F0 parameter of the target speaker speech signal as a second target speaker speech feature.

As described above, the similar speaker data selecting unit 55 may select at least one similar speaker speech signal in association with a target speaker speech signal by using a parameter representing a spectral feature (for example, spectral parameter) of a multi-speaker speech signal, and a parameter representing a basis frequency feature (for example, F0 parameter) of the multi-speaker speech signal. For this, the similar speaker data selecting unit 55 may be provided with a first target speaker speech feature (for example, spectral parameter) and a second target speaker speech feature (for example, F0 parameter) from the target speaker speech feature extracting unit 54. In addition, the similar speaker data selecting unit 55 may extract from the multi-speaker speech DB 14 a feature of a multi-speaker speech signal, that is, a first multi-speaker speech feature (for example, spectral parameter) and a second multi-speaker speech feature (for example, F0 parameter).

Based on this, the similar speaker data selecting unit 55 may divide at least one speech signal included in the multi-speaker speech database 14 by a partial unit of a sentence such as phoneme, syllable, word, etc., measure a similarity with a training subject speech signal based on the division unit, and select a speech signal with high similarity as a similar speaker speech signal.

The similar speaker speech feature determining unit 56 determines a speech feature in association with a similar speaker speech signal, and provides the determined speech feature to the acoustic parameter model training unit. For example, the similar speaker speech feature determining unit 56 outputs a spectral parameter of the similar speaker speech signal as a first similar speaker speech feature, and the similar speaker speech feature determining unit 56 outputs a F0 parameter of the similar speaker speech signal as a second similar speaker speech feature.

The similar speaker data selecting unit 55 may calculate a multi-speaker speech feature when performing selecting of a similar speaker. In addition, a similar speaker may be a speaker selected from one of the multiple speakers. Accordingly, the similar speaker speech feature determining unit 56 may be provided with a speech feature in association with a similar speaker, for example, a spectral parameter and a F0 parameter from the similar speaker data selecting unit 55. The same may be determined as first and second speech features of the similar speaker.

The acoustic parameter model training unit 57 may perform model training for a relation between the speech feature and text by using speech feature information provided from the target speaker speech feature extracting unit 54 and the similar speaker speech feature determining unit 56, and store and manage mapping information of the relation between the speech feature and the text in the deep neural network model database 58.

In detail, in consideration of context information, the acoustic parameter model training unit 57 performs model training for a relation between a first target speaker speech feature (spectral parameter) which is in association with the resulting of the signal division such as phoneme, syllable, word, etc. and a first similar speaker speech feature (spectral parameter). Similarly, the acoustic parameter model training unit 57 performs model training for a relation between a second target speaker speech feature (F0 parameter) which is in association with the resulting of the signal division and a second similar speaker speech feature (F0 parameter).

Further, the similar speaker data selecting unit 55 determines a similarity between a similar speaker speech signal and a target speaker speech signal when determining a similar speaker speech signal, and the above similarity may be provided to the acoustic parameter model training unit 57. In addition, the acoustic parameter model training unit 57 sets a weight for a first similar speaker speech feature or a similar speaker second speech feature based on the similarity between the similar speaker speech signal and the target speaker speech signal, and performs training for the first similar speaker speech feature or the second similar speaker speech feature.

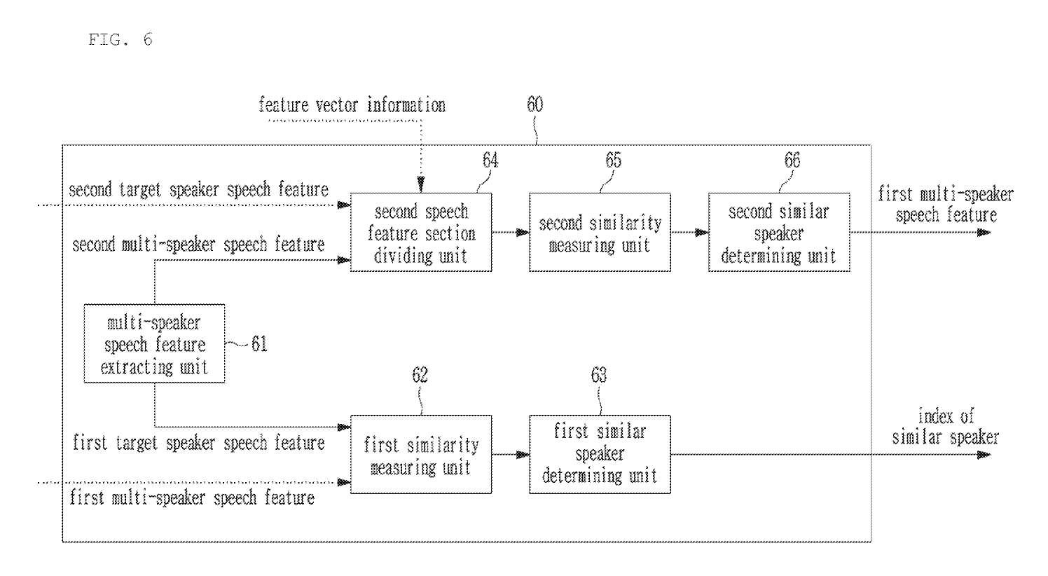

FIG. 6 is a view of a block diagram showing a detailed configuration of the similar speaker data selecting unit included in the speech signal training apparatus according to another embodiment of the present disclosure.

Referring to FIG. 6, a similar speaker data selecting unit 60 may include a multi-speaker speech feature extracting unit 61, a first similarity measuring unit 62, a first similar speaker determining unit 63, a second speech feature section dividing unit 64, a second similarity measuring unit 65, and a second similar speaker determining unit 66.

The multi-speaker speech feature extracting unit 61 extracts an acoustic parameter from the multi-speaker speech database 52. Various acoustic parameters may be included in a speech signal of a speaker, and various acoustic parameters required for performing training of a speech signal of a speaker may be extracted based on the same.

It is preferable for the multi-speaker speech feature extracting unit 61 to detect an acoustic parameter having a feature identical to the above acoustic parameter detected by the target speaker speech feature extracting unit 54. For example, the multi-speaker speech feature extracting unit 61 may extracts a parameter representing a spectral feature of a multi-speaker speech signal (for example, spectral parameter), and a parameter representing a basis frequency feature of a target speaker speech signal (for example, F0 parameter).

The first similarity measuring unit 62 may receive a first target speaker speech feature (for example, spectral parameter) from the target speaker speech feature extracting unit 54 which is described above, and receive a first multi-speaker speech feature (for example, spectral parameter) from the multi-speaker speech feature extracting unit 61 which is described above. In addition, the first similarity measuring unit 62 may measure a similarity with the first multi-speaker speech feature (for example, spectral parameter) based on the first the target speaker speech feature (for example, spectral parameter). For example, the first similarity measuring unit 62 may calculate a similarity of a spectral parameter between the target speaker and each of the multiple speakers. The first similarity measuring unit 62 may calculate a similarity of a spectral parameter between the target speaker and each of the multiple speakers by using a K-means clustering method, a method of a Euclidean distance of a Wavelet coefficient extracted from a basis frequency, a Kullback-Leibler divergence method, etc.

The calculated similarity may be provided to the first similar speaker determining unit 63, and the first similar speaker determining unit 63 may detect a multi-speaker speech signal having a feature similar to the first target speaker speech feature (for example, spectral parameter) by using the similarity. For example, the first similar speaker determining unit 63 may determine as a similar speaker one of the multiple speakers which corresponds to a case where the similarity for the first multi-speaker speech feature (for example, spectral parameter) is equal to or greater than a predefined threshold value. In addition, the first similar speaker determining unit 63 may output index information of the determined similar speaker.

The second speech feature section dividing unit 64 may receive a second target speaker speech feature (for example, F0 parameter) from the target speaker speech feature extracting unit 54, and receive a second multi-speaker speech feature (for example, F0 parameter) from the multi-speaker speech feature extracting unit 61.

In addition, the second speech feature section dividing unit 64 may receive a target speaker feature vector and a multi-speaker feature vector from the above described feature vector extracting unit 53.

Even though sentences are the same, a speech speed differs for each speaker, and thus a length of a speech signal may vary. Accordingly, in order to determine a similarity between a feature vector of the second target speaker speech feature (for example, F0 parameter) and a feature vector of the second multi-speaker speech feature (for example, F0 parameter), setting using a temporal alignment method is required such that the lengths of the entire sentences become the same. For this, the second speech feature section dividing unit 64 performs temporal alignment for the second target speaker speech feature (for example, F0 parameter) and for the second multi-speaker speech feature (for example, F0 parameter) based on the target speaker feature vector and the multi-speaker feature vector, and divides the second target speaker speech feature (for example, F0 parameter) and the second multi-speaker speech feature (for example, F0 parameter) based on the same time unit.

The second similarity measuring unit 65 determines a similarity between the second target speaker speech feature (for example, F0 parameter) and the second multi-speaker speech feature (for example, F0 parameter). For example, the second similarity measuring unit 65 may calculate a similarity between the second target speaker speech feature (for example, F0 parameter) and the second multi-speaker speech feature (for example, F0 parameter) by using a K-means clustering method, a method of a Euclidean distance of a Wavelet coefficient extracted from a basis frequency, a Kullback-Leibler divergence method, etc.

The second similar speaker determining unit 66 determines one of the multiple speakers which has a second speech feature (for example, F0 parameter) similar to the second target speaker speech feature (for example, F0 parameter) based on the similarity determined in the second similarity measuring unit 65, and selects the determined one of the multiple speakers as a similar speaker. In another embodiment of the present disclosure, a multi-speaker speech signal selected as described above may be defined as a similar speaker speech signal.

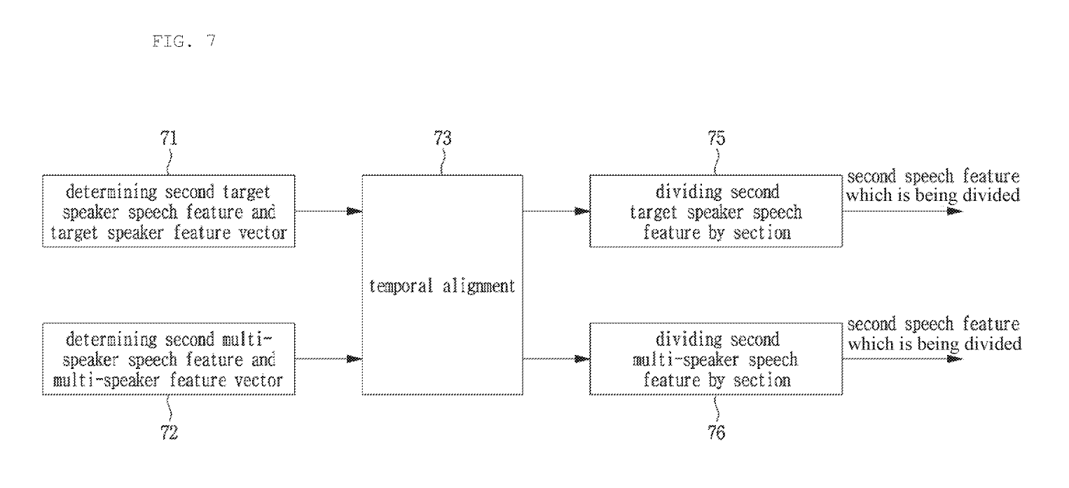

FIG. 7 is a view of an example showing where the second speech feature section dividing unit 64 of FIG. 6 performs temporal alignment for a speech signal.

In 71, the second speech feature section dividing unit 64 checks a second target speaker speech feature (for example, F0 parameter) provided from the target speaker speech feature extracting unit 54 and a feature vector provided from the feature vector extracting unit 53.

Then, in 72, the second speech feature section dividing unit 64 checks a second multi-speaker speech feature (for example, F0 parameter) provided from the multi-speaker speech feature extracting unit 61, and a feature vector provided from the feature vector extracting unit 53.

In 73, the second speech feature section dividing unit 64 performs temporal alignment for the second target speaker speech feature (for example, F0 parameter) and for the second multi-speaker speech feature (for example, F0 parameter) based on the received feature vector. In detail, the second speech feature section dividing unit 64 may perform temporal alignment for the second target speaker speech feature (for example, F0 parameter) and for the second multi-speaker speech feature by applying a dynamic time warping (DTW) algorithm by using the feature vector calculated as described above.

Then, in 75 and 76, the second speech feature section dividing unit 64 may divide the second target speaker speech feature (for example, F0 parameter) and the second multi-speaker speech feature by a unit of language information constituting a lower configuration of a sentence such as phoneme, word, etc. acoustic parameter.

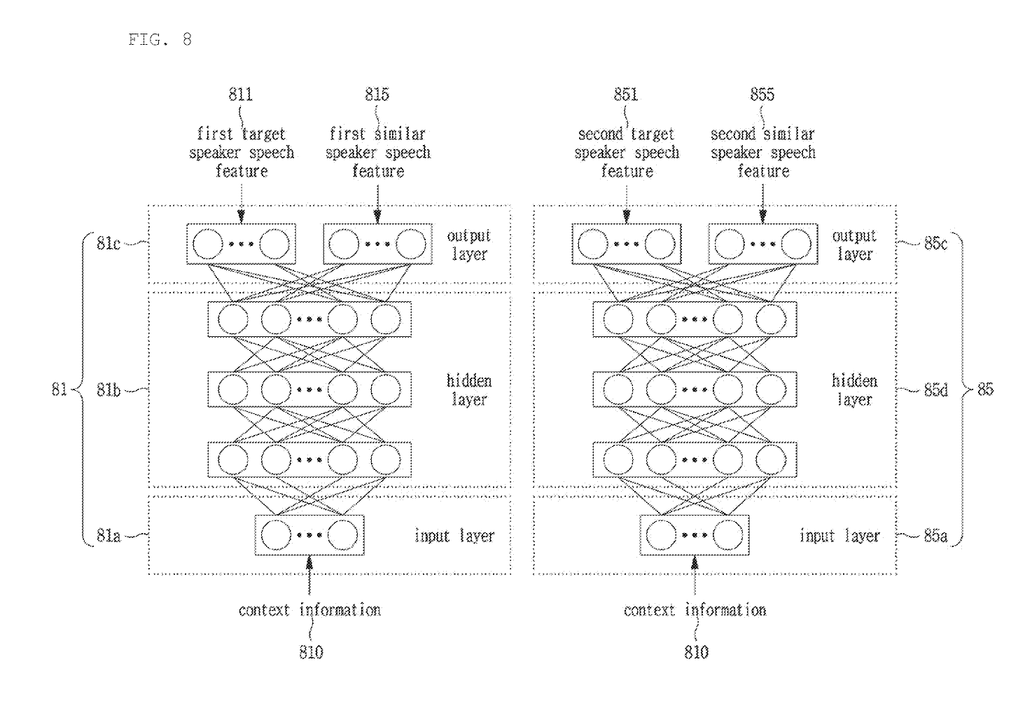

FIG. 8 is a view showing an example of a neural network model where the acoustic parameter model training unit 57 included in FIG. 5 uses a target speaker speech feature and a multi-speaker speech feature.

The acoustic parameter model training unit 57 may include a first speech feature training unit 81 and a second speech feature training unit 85.

The first speech feature training unit 81 may include an input layer 81a, a hidden layer 81b, and an output layer 81c. In the input layer 81a, context information 810 may be input, and in the output layer 81c, first speech features 811 and 81 (for example, spectral parameter) of the target speaker and the similar speaker may be input. Accordingly, the first speech feature training unit 81 may perform training that performs mapping a relation between the context information 800 of the input layer 81a and the first speech features 811 and 815 (for example, spectral parameter) of the target speaker and the similar speaker of the output layer 81c, and thus configure a deep neural network for a first speech feature.

In addition, the second speech feature training unit 85 may include an input layer 85a, a hidden layer 85b, and an output layer 85c. In the input layer 85a, context information 850 may be input, and in the output layer 85c, second speech features 851 and 855 (for example, F0 parameter) of the target speaker and the similar speaker may be input. Accordingly, the second speech feature training unit 85 may perform training that performs mapping a relation between the context information 850 of the input layer 85a and second speech features 851 and 855 (for example, F0 parameter) of the target speaker and the similar speaker of the output layer 85c, and thus configure a deep neural network for a second speech feature.

As described above, the acoustic parameter model training unit 57 configures a deep neural network by performing training for the first speech feature (for example, spectral parameter) and the second speech feature (for example, F0 parameter) through the first speech feature training unit 81 and the second speech feature training unit 85, and thus statistical model training accuracy may be improved. In addition, among multiple speakers, a similar speaker having a speech feature similar to a target speaker is selected, a deep neural network is configured by performing training using a speech feature of the similar speaker, and thus an accurate deep neural network model may be configured by using data of the similar speaker even though data of the target speaker is not sufficient.

In addition, by reflecting a weight based on a similarity with a second target speaker speech feature when performing training for a second similar speaker speech feature, training may be performed more closely to a feature included in a speech signal of the target speaker.

Further, the above described acoustic parameter model training unit 57 may further include a neural network adapting unit 57′. The above described acoustic parameter model training unit 57, as described above, may configure a deep neural network model (hereinafter, ‘first deep neural network model’) by using speech features of the target speaker and the similar speaker (for example, spectral parameter, F0 parameter, etc.), the neural network adapting unit 57′ may configure a deep neural network model that is more optimized to the target speaker (hereinafter, ‘second deep neural network model’) by further performing training for the first target speaker speech feature and for the second target speaker speech feature in addition to the first deep neural network model.

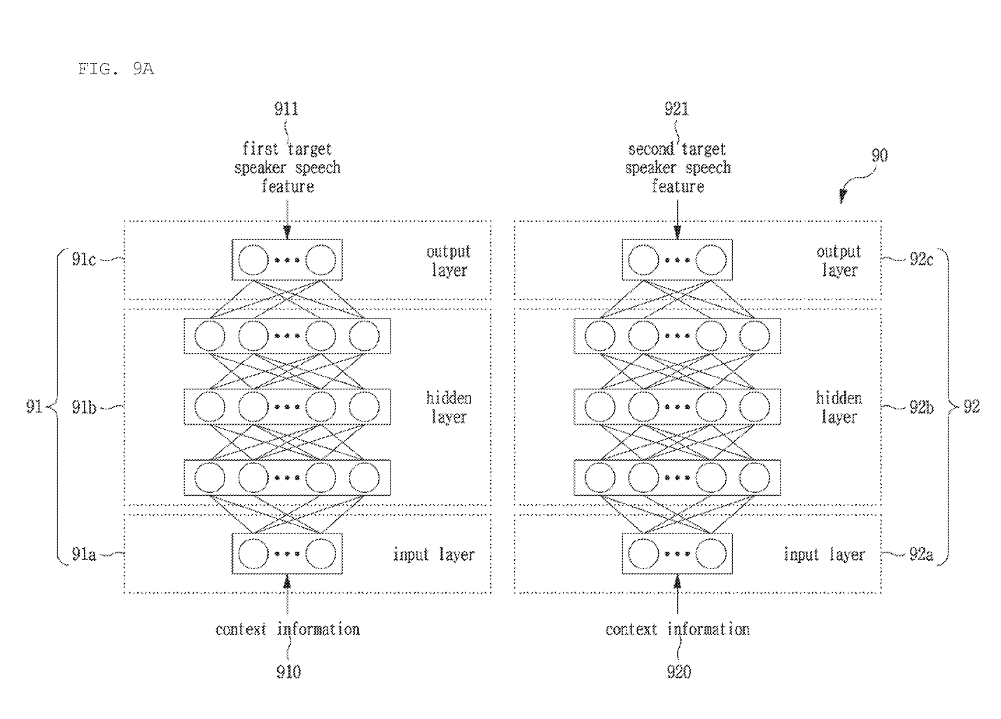

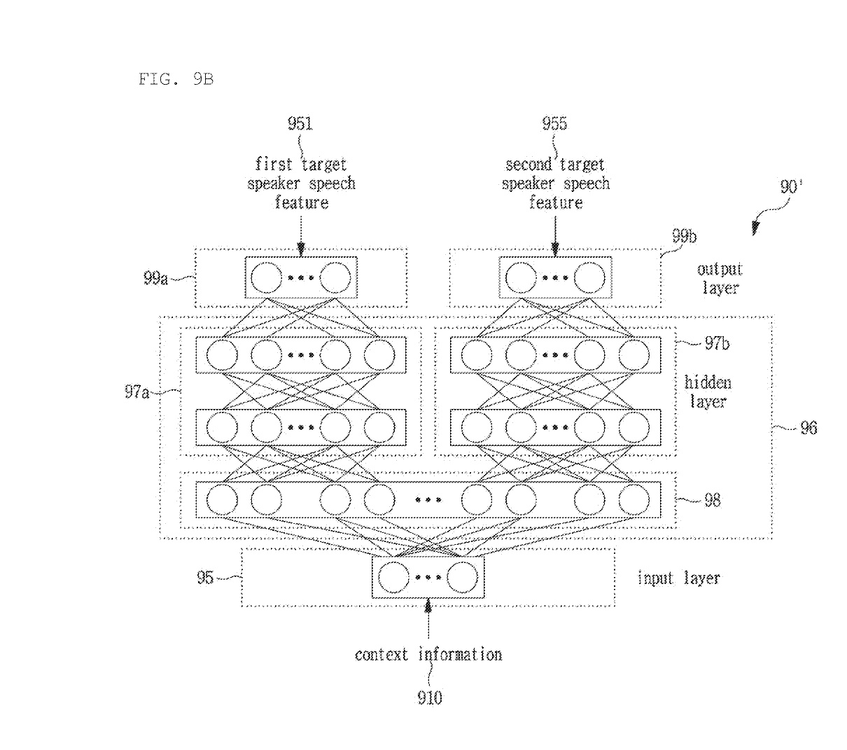

FIGS. 9A and 9B are views of an example showing a configuration of the neural network adapting unit included in the speech signal training apparatus according to another embodiment of the present disclosure.

Referring to FIG. 9A, a neural network adapting unit 90 may include a first speech feature adapting unit 91 and a second speech feature adapting unit 92.

The first speech feature adapting unit 91 may include an input layer 91a, a hidden layer 91b, and an output layer 91c. In the input layer 91a, context information 910 may be input, and in the output layer 91c, a first target speaker speech feature 911 (for example, spectral parameter) may be input. Accordingly, the first speech feature adapting unit 91 may perform training that performs mapping a relation between the context information 910 of the input layer 91a and the first target speaker speech feature 911 (for example, spectral parameter) of the output layer 91c, and thus configure a second deep neural network model for a first speech feature.

In addition, the second speech feature adapting unit 92 may include an input layer 92a, a hidden layer 92b, and an output layer 92c. In the input layer 92a, context information 920 may be input, and in the output layer 92c, a second target speaker speech feature 921 (for example, F0 parameter) may be input. Accordingly, the second speech feature adapting unit 92 may perform training that performs mapping a relation between the context information 920 of the input layer 92a and the second speech features 921 (for example, F0 parameter) of the target speaker and the similar speaker of the output layer 92c, and thus configure a second deep neural network model for a second speech feature.

As another example, referring to FIG. 9b, a neural network adapting unit 90′ may include a common input layer 95, a hidden layer 96, and individual output layers 99a and 99b. In the common input layer 95, context information 950 may be input, and in the individual output layers 99a and 99b, a first target speaker speech feature 951 (for example, spectral parameter) and a second target speaker speech feature 955 (for example, F0 parameter) may be input, respectively.

In addition, the hidden layer 96 may include individual hidden layers 97a and 97b, and the individual hidden layer 97a and 97b may configure a network by being respectively connected to the first target speaker speech feature 951 (for example, spectral parameter), and the second target speaker speech feature 955 (for example, F0 parameter). Further, the hidden layer 96 may include at least one common hidden layer 98, and the common hidden layer 98 may be configured to include a network node that becomes common between context information 950 and the first and second target speaker speech features 951 and 955 (or example, spectral parameter, F0 parameter).

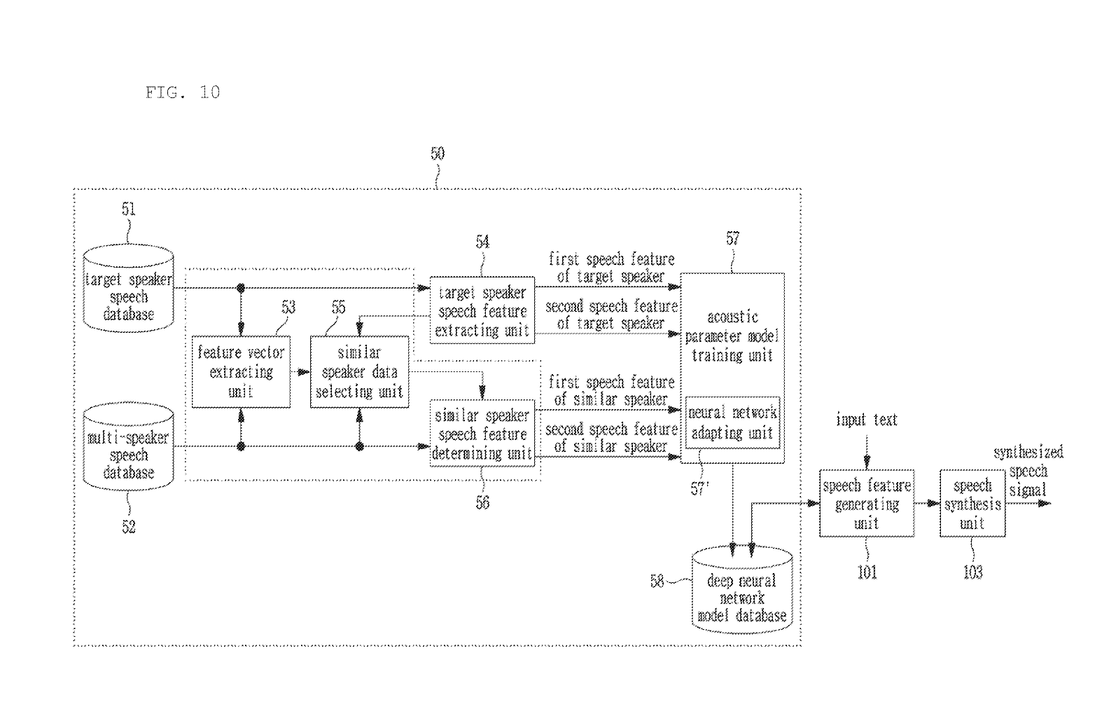

FIG. 10 is a view of a block diagram showing a configuration of a speech signal synthesis apparatus according to another embodiment of the present disclosure.

The speech signal synthesis apparatus according to another embodiment of the present disclosure includes the above described speech signal training apparatus 50 according to another embodiment of the present disclosure. In FIG. 10, for configurations identical to the above described speech signal synthesis apparatus 50 of FIG. 5, the same drawing reference numbers are given, and for detailed description related thereto, refer to FIG. 1 and the description thereof.

The speech signal training apparatus 50 performs model training for a relation between an acoustic parameter and text by using first and second features calculated based on an acoustic parameter detected from a target speaker speech signal, and a similar speaker speech signal selected form multi-speaker speech signals. Data obtained by the above training, that is, mapping information of a relation between the acoustic parameter and the text may be stored and managed in the deep neural network model DB 58.

The speech signal synthesis apparatus includes a sound image parameter generating unit 101 and a text-to-speech synthesis unit 103.

The sound image parameter generating unit 101 generates an acoustic parameter in association with input text based on data stored in the deep neural network model DB 58, that is, mapping information of a relation between an acoustic parameter and text. In addition, the text-to-speech synthesis unit 103 generates a synthesized speech signal in association with the input text by reflecting the generated acoustic parameter.

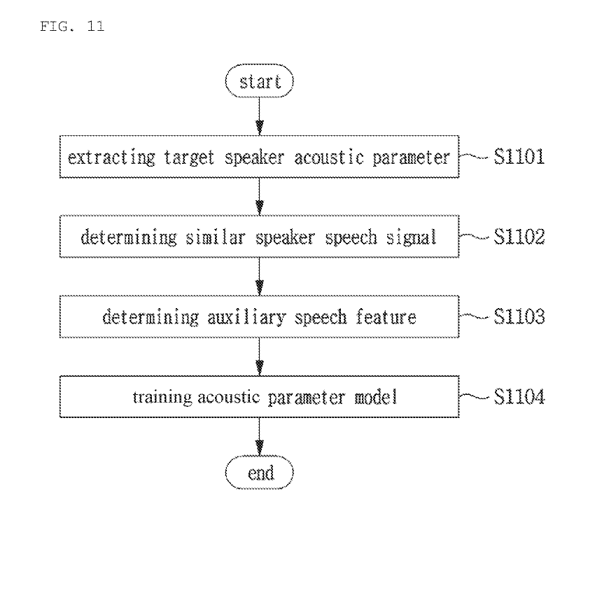

FIG. 11 is a view of a flowchart showing a speech signal training method according to an embodiment of the present disclosure.

The speech signal training method according to an embodiment of the present disclosure may be performed by the above described speech signal training apparatus.

First, a target speaker speech signal may be divided by a phoneme unit that is a minimum sound unit for distinguishing meaning of a word in a speech system of language, by a syllable unit that is a unit of speech giving one comprehensive sound feeling, and by a word unit that is used to form a sentence and typically shown with a space on either side when written or printed.

Although a text speech signal is configured with the same unit, the speech signal shows various patterns according to a conversation method, an emotional state, a composition of sentence. Accordingly, the text speech signal configured with the same unit may be configured with a speech signal of various patterns. For a target speaker speech signal, in order to perform training for respective various patterns, a large amount of data for the target speaker speech signal is required. However, data of the target speaker speech signal is hard to obtain, a training method capable of reflecting various patterns in a multi-speaker speech signal by using data is implemented.

In addition, when training is performed by using data of a multi-speaker speech signal, features of various patterns of a target speaker has to be represented. However, due to a feature of a training or learning algorithm, the trained speech signal becomes over-smoothing so that features of various patterns of a target speaker are not properly represented and the liveness may be degraded.

In order to solve the above problem, in the speech signal training method according to an embodiment of the present disclosure, among multi-speaker speech signals stored in a multi-speaker speech database, a speech signal including a feature similar to a target speaker speech signal for which training is performed, that is, a training subject speech signal, is selected and training or training is performed for the same.

For this, in step S1101, the speech signal training apparatus extracts an acoustic parameter of a training subject speech signal from a target speaker speech database storing target speaker speech signals.

In addition, a training subject speech signal may include a speech signal in a unit of a phoneme, a syllable, a word, etc.

In step S1102, the speech signal training apparatus detects at least one similar speaker speech signal in association with the training subject speech signal from the multi-speaker speech database storing speech signals of a plurality of users.

In detail, the speech signal training apparatus calculates an acoustic parameter (for example, excitation parameter) of a target speaker speech signal stored in the target speaker speech database, and an acoustic parameter of a multi-speaker speech signal stored in the multi-speaker speech database, and determines a feature vector of each acoustic parameter (for example, excitation parameter).

Then, the speech signal training apparatus determines a similarity between a feature vector of the target speaker speech signal and a feature vector of the multi-speaker speech signal. For example, the speech signal training apparatus calculates the similarity between the feature vector of the target speaker speech signal and the feature vector of the multi-speaker speech signal by using a K-means clustering method, a method of using a Euclidean distance of a Wavelet coefficient extracted from a basis frequency, a Kullback-Leibler divergence method, etc.

Then, based on the similarity between the feature vector of the target speaker speech signal and the feature vector of the multi-speaker speech signal, the speech signal training apparatus may select a multi-speaker speech signal similar to the target speaker speech signal. In an embodiment of the present disclosure, the multi-speaker speech signal selected as described above may be defined as a similar speaker speech signal.

Even though sentences are the same, a speech speed differs for each speaker, and thus a length of speech signal configured in a phoneme, a syllable, or a word unit may vary. Accordingly, in order to determine a similarity between a feature vector for a target speaker speech signal and a feature vector for a multi-speaker speech signal, setting using a temporal alignment method is required such that the lengths of the entire sentences of speech signals become the same. For this, before calculating a similarity between a feature vector for a target speaker speech signal and a feature vector for a multi-speaker speech signal, the speech signal training apparatus may perform temporal alignment for a speech signal that becomes a subject of calculating a similarity.

In detail, the speech signal training apparatus determines an acoustic parameter (for example, excitation parameter) from the target speaker speech signal and a feature vector in association with the same. Then, the speech signal training apparatus determines an acoustic parameter (for example, excitation parameter) from the multi-speaker speech signal and a feature vector in association with the same.

The speech signal training apparatus may determine feature vectors from the target speaker speech signal and the multi-speaker speech signal, and perform temporal alignment for an acoustic parameter (for example, excitation parameter) based on the determined feature vector.

In one embodiment, the speech signal training apparatus may determine a feature vector of acoustic parameters (for example, excitation parameter) calculated from the target speaker speech signal and the multi-speaker speech signal such as mel-frequency cepstral coefficient (MFCC), first to fourth formants (F1˜F4), line spectral frequency (LSF), etc. Then, by using the feature vector determined as described above, the speech signal training apparatus performs temporal alignment for an acoustic parameter (for example, excitation parameter) determined from the target speaker speech signal and the multi-speaker speech signal by applying a dynamic time warping (DTW) algorithm.

Then, the speech signal training apparatus divides the acoustic parameter (for example, excitation parameter) determined from the target speaker speech signal and the multi-speaker speech signal by a unit of language information which constitutes a lower configuration in a sentence such as phoneme, syllable, word, etc.

Meanwhile, in step S1103, the speech signal training apparatus may determine an auxiliary speech feature vector by using information determined when determining the similar speaker speech signal in step S1102. For example, the speech signal training apparatus may determine an auxiliary speech feature based on the acoustic parameter (for example, excitation parameter) of the similar speaker speech signal. In other words, the speech signal training apparatus may generate an auxiliary speech feature vector by reflecting a weight according to the similarity of the acoustic parameter (for example, excitation parameter) of the similar speaker speech signal and the target speaker speech signal in the acoustic parameter of the similar speaker.

Then, in step S1104, the speech signal training apparatus performs model training for a relation between the acoustic parameter and text by using the auxiliary speech feature vector calculated based on the acoustic parameter detected from the target speaker speech signal, and the similar speaker speech signal, and store mapping information of the relation between the acoustic parameter and the text in the acoustic parameter model DB.

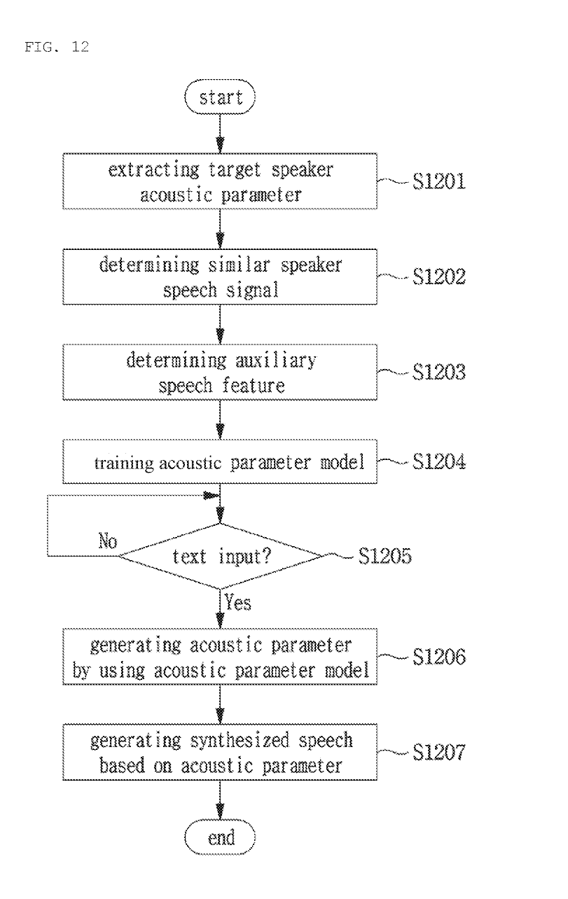

FIG. 12 is a view of a flowchart showing steps of the speech signal synthesis method according to an embodiment of the present disclosure.

The speech signal synthesis method according to an embodiment of the present disclosure may be performed by the above described speech signal synthesis apparatus.

The speech signal synthesis method may fundamentally include steps S1201, S1202, S1203, and S1204 of the speech signal training method, and for detailed operations of the above steps S1201, S1202, S1203, and S1204 of the speech signal training method, refer to FIG. 11 and steps S1101, S1102, S1103, and S1104 described in the related explanation.

First, the speech signal synthesis apparatus performs model training for a relation between an acoustic parameter and text by using an acoustic parameter detected from a target speaker speech signal and an auxiliary feature vector calculated based on a similar speaker speech signal selected from a multi-speaker speech signal. Data obtained by the above training, that is, mapping information of the relation between the acoustic parameter and the text may be stored and managed in the acoustic parameter model DB.

In the above environment, when text for text-to-speech synthesis is input (S1205-YES), in step S1206, the speech signal synthesis apparatus generates an acoustic parameter in association with the input text based on data stored in the acoustic parameter model DB, that is, mapping information of a relation between an acoustic parameter and text. Then, in step S1207, the speech signal synthesis apparatus generates a synthesized speech signal in association with the input text by reflecting the generated acoustic parameter.

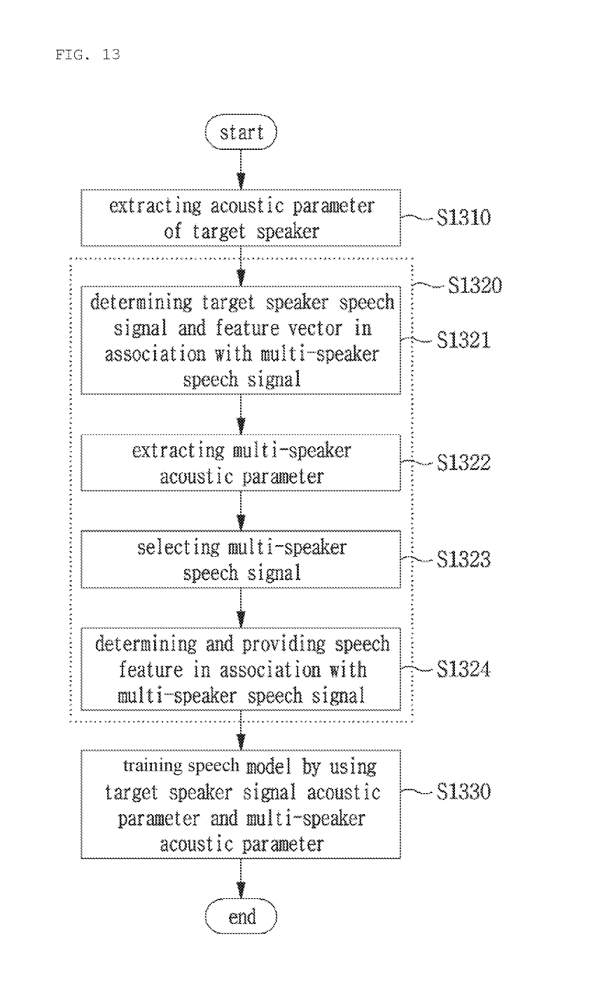

FIG. 13 is a view of a flowchart showing steps of a speech signal training method according to another embodiment of the present disclosure.

The speech signal training method according to another embodiment of the present disclosure may be performed by the above described speech signal training apparatus according to another embodiment of the present disclosure.

A target speaker speech signal may be divided by a phoneme unit that is a minimum sound unit for distinguishing a meaning of a word in a phonetic system of language. The speech signal shows various patterns according to a conversation method, an emotional state, a composition of sentence so that various patterns may be represented in a speech signal in response to a conversation method, an emotional state, a composition of sentence even though a speech signal of the same phoneme unit is provided. For a target speaker speech signal, in order to perform training for respective various patterns, a large amount of data for the target speaker speech signal is required. However, data of the target speaker speech signal is hard to obtain, a training method capable of reflecting various patterns in a multi-speaker speech signal by using data is implemented.

In addition, when training is performed by using data of a multi-speaker speech signal, a feature of various patterns of a target speaker has to be represented. However, due to a feature of a training algorithm, the trained speech signal becomes over-smoothing so that features of various patterns of a target speaker are not properly represented the and the liveness may be degraded.

In order to solve the above problem, the speech signal training apparatus according to another embodiment of the present disclosure performs training for a speech signal by selecting the same having a feature similar to a target speaker speech signal that becomes a target for which training performed, that is, a training subject speech signal, among multi-speaker speech signals stored in the multi-speaker speech database.

Based on this, the speech signal training method may include step S1310 of detecting a speech feature of a target speaker speech signal, and step S1320 of detecting a speech feature of a similar speaker speech signal selected from multi-speaker speech signals.

In step S1310, the speech signal training apparatus may extract an acoustic parameter of the training subject speech signal from the target speaker speech database. Various parameters may be included in a speech signal of a speaker, and the speech signal training apparatus may extract various acoustic parameters required for performing training for a speech signal of a speaker based on the same. Particularly, the speech signal training apparatus may extract a parameter representing a spectral feature of the target speaker speech signal (for example, spectral parameter), and a parameter representing a basis frequency feature of the target speaker speech signal (for example, F0 parameter).

Step S1320 may include step S1321 of extracting a feature vector for performing temporal alignment of a parameter representing a basis frequency feature. In step S1321, the speech signal training apparatus may calculate a feature vector required for performing temporal alignment by detecting a mel-frequency cepstral coefficient (MFCC), first to fourth formants (F1˜F4), a line spectral frequency (LSF), etc. of the target speaker speech signal and the multi-speaker speech signal.

Step S1320 may include step S1322 of extracting an acoustic parameter of a training subject speech signal from the multi-speaker speech database. For example, in step S1322, the speech signal training apparatus may determine a multi-speaker speech signal from a database storing multi-speaker speech signals, and extract a parameter representing a spectral feature (for example, spectral parameter) of the multi-speaker speech signal and a parameter representing a basis frequency feature (for example, F0 parameter) of the multi-speaker speech signal.

In step S1323, the speech signal training apparatus may select at least one similar speaker speech signal in association with the target speaker speech signal by using the parameter representing a spectral feature (for example, spectral parameter) of the multi-speaker speech signal, and the parameter representing a basis frequency feature (for example, F0 parameter) of the multi-speaker speech signal. In detail, the speech signal training apparatus may divide at least one speech signal included in the multi-speaker speech database 14 by a partial unit of a sentence such as phoneme, syllable, word, etc., measure a similarity with the training subject speech signal based on the resulting unit, and select a speech signal with high similarity as a similar speaker speech signal.

In step S1324, the speech signal training apparatus may determine a parameter representing a spectral feature (for example, spectral parameter) and a parameter representing a basis frequency feature (for example, F0 parameter) of the speech feature of the speech signal determined as a similar speaker. In other words, by referring the speech feature of one of the multiple speakers which is detected in step S1322, a speech feature in association with the similar speaker may be determined.

Hereinafter, step S1323 of selecting the above described similar speaker speech signal will be described in detail.

The speech signal training apparatus may receive a first speech feature (for example, spectral parameter) of the target speaker and a first multi-speaker speech feature (for example, spectral parameter), and based on the first target speaker speech feature (for example, spectral parameter), a similarity with the first multi-speaker speech feature (for example, spectral parameter) may be measured. For example, the speech signal training apparatus may determine a feature vector of spectral parameter between the target speaker and each of the multiple speakers, and calculate a similarity between the determined feature vectors. The speech signal training apparatus may calculate a similarity between the determined feature vectors by using a K-means clustering, a method of a Euclidean distance of a Wavelet coefficient extracted from a basis frequency, a Kullback-Leibler divergence method, etc.

By using the calculated similarity, a multi-speaker speech signal that is similar to the first target speaker speech feature (for example, spectral parameter) may be detected. For example, the speech signal training apparatus may determine as a similar speaker one of the multiple speakers which corresponds to a case where the similarity for the first multi-speaker speech feature (for example, spectral parameter) is equal to or greater than a predefined threshold value. Then, the speech signal training apparatus may output index information of the determined similar speaker.

In addition, speech signal training apparatus determines a second target speaker speech feature (for example, F0 parameter) and a second multi-speaker speech feature (for example, F0 parameter), and determine a feature vector in association with each of the second target speaker speech feature (for example, F0 parameter) and the second multi-speaker speech feature (for example, F0 parameter) by referencing the feature vector determined in step S1321. Then, the speech signal training apparatus performs temporal alignment for the second target speaker speech feature (for example, F0 parameter) and for the second multi-speaker speech feature (for example, F0 parameter) by using the feature vector of the second target speaker speech feature, and the feature vector of the second multi-speaker speech feature, and determines a similarity between aligned speech features. For example, the speech signal training apparatus may calculate a similarity between the second target speaker speech feature (for example, F0 parameter) and the second multi-speaker speech feature (for example, F0 parameter) which are temporally aligned by using a K-means clustering), a method of a Euclidean distance of a Wavelet coefficient extracted from a basis frequency, a Kullback-Leibler divergence method, etc.

The speech signal training apparatus may determine one of the multiple speakers which includes a feature vector similar to the second target speaker speech feature (for example, F0 parameter) based on the determined similarity, and select the determined one of the multiple speakers as a similar speaker. In an embodiment of the present disclosure, the multi-speaker speech signal selected as described above may be defined as a similar speaker speech signal.

Even though sentences are the same, a speech speed differs for each speaker, and thus a length of speech signal may vary. Accordingly, in order to determine a similarity between the second target speaker speech feature (for example, F0 parameter) and the second multi-speaker speech feature (for example, F0 parameter), setting using a temporal alignment method such that the lengths of the entire sentences become the same is required. For this, the speech signal training apparatus may perform temporal alignment for a speech signal that becomes a subject of calculating a similarity by using the feature vector of the target speaker speech signal and the feature vector of the multi-speaker speech signal.

Hereinafter, operation of performing, by the speech signal training apparatus, temporal alignment for a speech signal that becomes a subject of calculating a similarity will be described.

First, the speech signal training apparatus may extract each of a feature vector required for performing temporal alignment of the second target speaker speech feature (for example, F0 parameter) and a feature vector required for performing temporal alignment of the second multi-speaker speech feature (for example, F0 parameter).

In one embodiment, in order to extract a feature vector required for performing temporal alignment from speech signals within the target speaker database and the multi-speaker database, the speech signal training apparatus may calculate a feature vector from speech signals within the target speaker database and the multi-speaker database such as mel-frequency cepstral coefficient (MFCC), formants (F1˜F4), line spectral frequency (LSF), etc.

The speech signal training apparatus may perform temporal alignment for the second target speaker speech feature (for example, F0 parameter) and for the second multi-speaker speech feature (for example, F0 parameter) based on the calculated feature vector. In other words, the speech signal training apparatus, as described above, perform temporal alignment for the second target speaker speech feature and for the second multi-speaker speech feature (for example, F0 parameter) by applying a dynamic time warping (DTW) algorithm by using the calculated feature vector.

Then, the speech signal training apparatus may divide each acoustic parameter of the second target speaker speech feature and the second multi-speaker speech feature (for example, F0 parameter) by a unit of language information constituting a lower configuration of a sentence such as phoneme, word, etc. Then, for calculating a similarity of the resulting unit, the speech signal training apparatus may provide the second target speaker speech feature (for example, F0 parameter) and the second multi-speaker speech feature (for example, F0 parameter) which are divided by the resulting unit.

Meanwhile, in step S1330, the speech signal training apparatus performs model training for a relation between the speech feature and text by using the speech feature of the target speaker and the speech feature of the similar speaker, and may store mapping information of the relation between the speech feature and the text in a deep neural network model database.

For example, for the speech signal divided by a phoneme, a syllable, a word, etc. in consideration of context information, the speech signal training apparatus performs model training for a relation between the first target speaker speech feature (spectral parameter) and the first similar speaker speech feature (spectral parameter) which are in association with the speech signal that is divided as above. Similarly, an acoustic parameter model training unit 57 performs model training for a relation between the second target speaker speech feature (F0 parameter) and the second similar speaker speech feature (F0 parameter) which are associated with the speech signal that is divided as above.

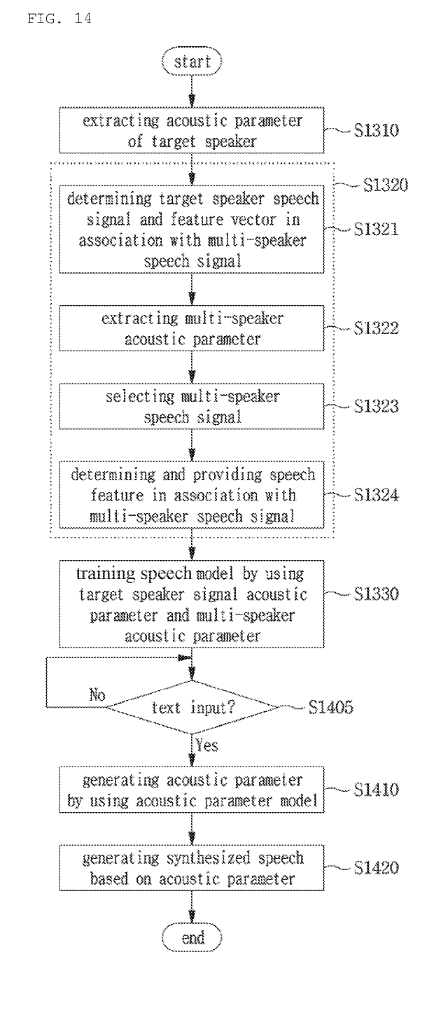

In detail, referring to FIG. 14, in an input layer 81a, context information 810 may be input, and in an output layer 81c, first speech features 811 and 815 (for example, spectral parameter) of the target speaker and the similar speaker may be input. Accordingly, the speech signal training apparatus performs training that performs mapping a relation between the context information 800 of the input layer 81a and first speech features 811 and 815 (for example, spectral parameter) of the target speaker and the similar speaker of the output layer 81c, and configure a deep neural network of the first speech feature.

Then, in an input layer 85a, context information 850 may be input, in an output layer 85c, second speech features 851 and 855 (for example, F0 parameter) of the target speaker and the similar speaker may be input. Accordingly, the speech signal training apparatus performs training that performs mapping a relation between the context information 850 of the input layer 85a and the second speech features 851 and 855 (for example, F0 parameter) of the speaker and the similar speaker of the output layer 85c, and configure a deep neural network for the second speech feature.

As described above, the speech signal training apparatus may improve training accuracy of a statistical model by configuring a deep neural network that performs training for each of the first speech feature (for example, spectral parameter) and the second speech feature (for example, F0 parameter). In addition, among multiple speakers, a deep neural network is configured by selecting a similar speaker having a speech feature similar to a target speaker, and performing training using a similar speaker speech feature, and thus a more accurate deep neural network model may be configured by using data of the similar speaker even though data of the target speaker is insufficient.

Further, when performing training for a second similar speaker speech feature, by reflecting a weight based on a similarity with the second target speaker speech feature, training may be performed more closely to a feature included in a speech signal of the target speaker.

Further, in step S1323, a similarity between the similar speaker speech signal and the target speaker speech signal may be determined, and in step S1330, training of an acoustic parameter model may be performed by using the above similarity. For example, the speech signal training apparatus may set a weight for the first similar speaker speech feature or the second similar speaker speech feature based on the similarity between the similar speaker speech signal and the target speaker speech signal, and perform training for the first similar speaker speech feature or the second similar speaker speech feature by reflecting the set weight.

FIG. 14 is a view of a flowchart showing a speech signal synthesis method according to another embodiment of the present disclosure.

The speech signal synthesis method according to another embodiment of the present disclosure may be performed by the above described speech signal synthesis apparatus according to another embodiment of the present disclosure.

In FIG. 14, the same drawing reference numbers are given to the speech signal training method of FIG. 13, the specific description related thereto is shown in FIG. 13, and for the description for the same, refer to FIG. 13 and the description thereof.

In the speech signal training method (S1310, S1320, and S1330), model training for a relation between an acoustic parameter and text is performed by using first and second speech features calculated based on an acoustic parameter detected from a target speaker speech signal and a similar speaker speech signal selected from multi-speaker speech signals. Data obtained by the above training, that is, mapping information of a relation between an acoustic parameter and text may be stored and managed in a deep neural network model DB.

In the above environment, when text is input for text-to-speech synthesis (S1405-TES), in step S1410, the speech signal synthesis apparatus generates an acoustic parameter in association with the input text based on data stored in the deep neural network model DB, that is, mapping information of a relation between an acoustic parameter and text.

Then in step S1420, the speech signal synthesis apparatus generates a synthesized speech signal in association with the input text by reflecting the generated acoustic parameter.

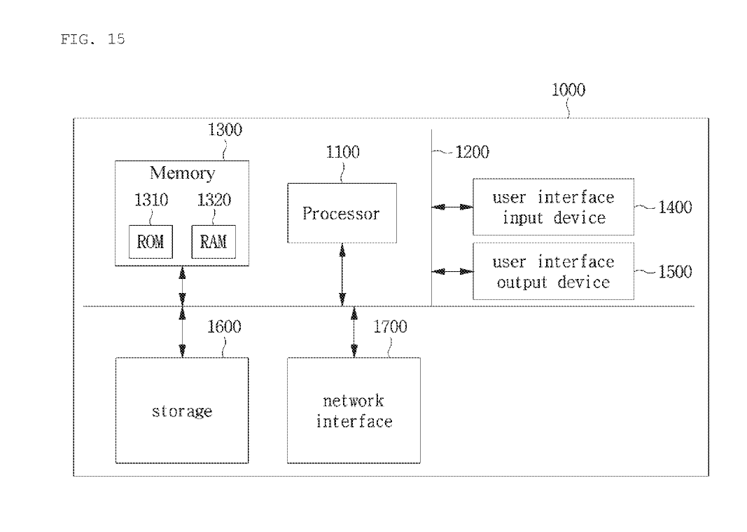

FIG. 15 is a view of a block diagram showing an example of a computing system that executes a speech signal training method/apparatus, a speech signal training method/apparatus, and a speech signal synthesis method/apparatus according to various embodiments of the present disclosure.

Referring to FIG. 15, a computing system 1000 may include at least one processor 1100 connected through a bus 1200, a memory 1300, a user interface input device 1400, a user interface output device 1500, a storage 1600, and a network interface 1700.

The processor 1100 may be a central processing unit or a semiconductor device that processes commands stored in the memory 1300 and/or the storage 1600. The memory 1300 and the storage 1600 may include various volatile or nonvolatile storing media. For example, the memory 1300 may include a ROM (Read Only Memory) and a RAM (Random Access Memory).

Accordingly, the steps of the method or algorithm described in relation to the embodiments of the present disclosure may be directly implemented by a hardware module and a software module, which are operated by the processor 1100, or a combination of the modules. The software module may reside in a storing medium (that is, the memory 1300 and/or the storage 1600) such as a RAM memory, a flash memory, a ROM memory, an EPROM memory, an EEPROM memory, a register, a hard disk, a detachable disk, and a CD-ROM. The exemplary storing media are coupled to the processor 1100 and the processor 1100 can read out information from the storing media and write information on the storing media. Alternatively, the storing media may be integrated with the processor 1100. The processor and storing media may reside in an application specific integrated circuit (ASIC). The ASIC may reside in a user terminal. Alternatively, the processor and storing media may reside as individual components in a user terminal.

The exemplary methods described herein were expressed by a series of operations for clear description, but it does not limit the order of performing the steps, and if necessary, the steps may be performed simultaneously or in different orders. In order to achieve the method of the present disclosure, other steps may be added to the exemplary steps, or the other steps except for some steps may be included, or additional other steps except for some steps may be included.

Various embodiments described herein are provided to not arrange all available combinations, but explain a representative aspect of the present disclosure and the configurations about the embodiments may be applied individually or in combinations of at least two of them.

Further, various embodiments of the present disclosure may be implemented by hardware, firmware, software, or combinations thereof. When hardware is used, the hardware may be implemented by at least one of ASICs (Application Specific Integrated Circuits), DSPs (Digital Signal Processors), DSPDs (Digital Signal Processing Devices), PLDs (Programmable Logic Devices), FPGAs (Field Programmable Gate Arrays), a general processor, a controller, a micro controller, and a micro-processor.

The scope of the present disclosure includes software and device-executable commands (for example, an operating system, applications, firmware, programs) that make the method of the various embodiments of the present disclosure executable on a machine or a computer, and non-transitory computer-readable media that keeps the software or commands and can be executed on a device or a computer.

What is claimed is:

1. An apparatus for training a speech signal, the apparatus comprising:
a target speaker speech database storing a target speaker speech signal;
a multi-speaker speech database storing a multi-speaker speech signal;
a target speaker acoustic parameter extracting unit extracting an acoustic parameter of a training subject speech signal from the target speaker speech signal;
a similar speaker acoustic parameter determining unit extracting at least one similar speaker speech signal from the multi-speaker speech signals, and determining an auxiliary speech feature of the similar speaker speech signal; and
an acoustic parameter model training unit determining an acoustic parameter model by performing model training for a relation between the acoustic parameter and text by using the acoustic parameter and the auxiliary speech feature, and setting mapping information of the relation between the acoustic parameter model and the text.

2. The apparatus of claim 1, wherein the similar speaker acoustic parameter determining unit extracts the at least one similar speaker speech signal based on a similarity with the training subject speech signal.

3. The apparatus of claim 1, wherein the similar speaker acoustic parameter determining unit includes:
a similar speaker speech signal determining unit determining the at least one similar speaker speech signal based on a similarity between the training subject speech signal and the multi-speaker speech signal; and
an auxiliary speech feature determining unit determining the auxiliary speech feature of the at least one similar speaker speech signal.

4. The apparatus of claim 3, wherein the similar speaker speech signal determining unit includes:
a similarity determining unit determining a similarity between feature parameters of the target speaker speech signal and the multi-speaker speech signal; and
a similar speaker speech signal selecting unit determining the similar speaker speech signal from the multi-speaker speech signal based on the similarity between feature parameters of the target speaker speech signal and the multi-speaker speech signal.

5. The apparatus of claim 4, wherein the similarity determining unit includes a feature parameter section dividing unit that calculates the feature parameter of the target speaker speech signal, and divides the feature parameters by a predetermined section unit and the feature parameter of the multi-speaker speech signal by performing temporal alignment for the feature parameter of the target speaker speech signal and the feature parameter of the multi-speaker speech signal.

6. The apparatus of claim 4, wherein the similarity determining unit includes a similarity measuring unit that measures a similarity between the feature parameter of the target speaker speech signal that is divided by the predetermined section unit and the feature parameter of the multi-speaker speech signal that is divided by the predetermined section unit.

7. The apparatus of claim 1, wherein the auxiliary speech feature includes an excitation parameter.

8. The apparatus of claim 1, wherein the similar speaker acoustic parameter determining unit extracts the at least one similar speaker speech signal by using an excitation parameter of the training subject speech signal and an excitation parameter of the multi-speaker speech signal.

9. The apparatus of claim 2, wherein the similar speaker acoustic parameter determining unit extracts the at least one similar speaker speech signal based on a similarity between an excitation parameter of the training subject speech signal and an excitation parameter of the multi-speaker speech signal.

10. A method of training a speech signal, the method comprising:
extracting an acoustic parameter of a training subject speech signal from a target speaker speech database storing a target speaker speech signal;
extracting at least one similar speaker speech signal from a multi-speaker speech database storing a multi-speaker speech signal;
determining an auxiliary speech feature of the similar speaker speech signal; and
determining an acoustic parameter model by performing model training of a relation between the acoustic parameter and text by using the acoustic parameter and the auxiliary speech feature, and setting mapping information of the relation between the acoustic parameter model and the text.

11. An apparatus for training a speech signal, the apparatus comprising:
a target speaker speech database storing a target speaker speech signal;
a multi-speaker speech database storing a multi-speaker speech signal; and
a target speaker acoustic parameter extracting unit extracting first and second target speaker speech features from the target speaker speech signal;
a similar speaker data selecting unit extracting first and second multi-speaker speech features from the multi-speaker speech signal, and selecting at least one similar speaker speech signal based on the extracted first and second multi-speaker speech features and the extracted first and second target speaker speech features;
a similar speaker speech feature determining unit determining first and second speech features of the similar speaker speech signal; and
a speech feature model training unit performing model training for a relation between the first and second speech features and text based on the first and seconds target speaker speech features of the target speaker and the similar speaker, and setting mapping information of the relation between the first and second speech features and the text.

12. The apparatus of claim 11, wherein the similar speaker data selecting unit determines the at least one similar speaker speech signal based on a similarity between first and second target speaker speech features and the first and second multi-speaker speech features.

13. The apparatus of claim 11, wherein the similar speaker data selecting unit includes:
a first similar speaker determining unit determining a first similar speaker based on a similarity between a first target speaker speech feature and a first multi-speaker speech feature; and
a second similar speaker determining unit determining a second similar speaker based on a similarity between a second target speaker speech feature of the and a second multi-speaker speech feature.

14. The apparatus of claim 13, wherein the first similar speaker determining unit includes:
a first similarity measuring unit determining a similarity between the first target speaker speech feature and the first multi-speaker speech feature; and
a first similar speaker determining unit determining the similar speaker speech signal from the multi-speaker speech signal based on the similarity between the first target speaker speech feature and the first multi-speaker speech feature.

15. The apparatus of claim 13, wherein the second similar speaker determining unit includes:
a second similarity measuring unit determining a similarity between the second target speaker speech feature and the second multi-speaker speech feature; and
a second similar speaker determining unit determining the similar speaker speech signal from the multi-speaker speech signal based on the similarity between the second target speaker speech feature and the second multi-speaker speech feature.

16. The apparatus of claim 15, wherein the second similar speaker determining unit includes a second speech feature section dividing unit dividing the second target speaker speech feature and the second multi-speaker speech feature by a preset section unit by performing temporal alignment for the second target speaker speech feature and the second multi-speaker speech feature.

17. The apparatus of claim 12, further comprising a feature vector extracting unit extract a feature vector of the target speaker speech signal and a feature vector of the multi-speaker speech signal, and providing the extracted feature vector of the target speaker speech signal and the feature vector of the multi-speaker speech signal to the similar speaker data selecting unit.

18. The apparatus of claim 17, wherein the similar speaker data selecting unit performs temporal alignment for the second target speaker speech feature and for the second multi-speaker speech feature based on the feature vector of the target speaker speech signal and the feature vector of the multi-speaker, and calculates a similarity between the second target speaker speech feature and the second multi-speaker speech feature.

19. The apparatus of claim 11, wherein the similar speaker speech feature determining unit determines a weight based on the first and second target speaker speech features and the first and second speech similar speaker features, and applies the weight to the first and second similar speaker speech features.

20. An apparatus for speech synthesis, the apparatus comprising:
a target speaker speech database storing a target speaker speech signal; a multi-speaker speech database storing a multi-speaker speech signal; a target speaker acoustic parameter extracting unit extracting an acoustic parameter of a training subject speech signal from the target speaker speech signal;
a similar speaker acoustic parameter determining unit extracting at least one similar speaker speech signal from the multi-speaker speech signals, and determining an auxiliary speech feature of the similar speaker speech signal;
an acoustic parameter model training unit determining an acoustic parameter model by performing model training for a relation between the acoustic parameter and text by using the acoustic parameter and the auxiliary speech feature, and setting mapping information of the relation between the acoustic parameter model and the text; and
an speech signal synthesizing unit generating the acoustic parameter in association with input text based on the mapping information of the relation between the acoustic parameter and the text, and generating a synthesized speech signal in association with the input text.
